(19) United States
(12) Patent Application Publication
(10) Pub. No.: US 2026/0180200 A1
(43) Pub. Date: Jun. 25, 2026

(54) INTELLIGENT REFLECTING SURFACE AND REFLECTING SYSTEM

(71) Applicant: Japan Display Inc., Tokyo (JP)

(72) Inventors: Daijiro TAKANO, Tokyo (JP); Mitsuhiro SUGAWARA, Tokyo (JP); Mitsutaka OKITA, Tokyo (JP)

(73) Assignee: Japan Display Inc., Tokyo (JP)

(21) Appl. No.: 19/545,070

(22) Filed: Feb. 20, 2026

Related U.S. Application Data
(63) Continuation of application No. PCT/JP2024/029180, filed on Aug. 16, 2024.

(30) Foreign Application Priority Data
Sep. 5, 2023 (JP) 2023-143620

(51) Int. Cl. H01Q 15/16

(52) U.S. Cl. CPC H01Q 15/165

(57) ABSTRACT

An intelligent reflecting surface comprises a plurality of reflecting devices, the plurality of reflecting devices is arranged adjacent to each other, the plurality of reflecting devices includes a first reflecting device and a second reflecting device adjacent to the first reflecting device, a reflecting surface of the first reflecting device forms an angle θ with a reflecting surface of the second reflecting device, and the angle θ is greater than 0° and less than 90°.

### CROSS-REFERENCE TO RELATED APPLICATIONS

This application is a Continuation of International Patent Application No. PCT/JP2024/029180, filed on Aug. 16, 2024, which claims the benefit of priority to Japanese Patent Application No. 2023-143620, filed on Sep. 5, 2023, the entire contents of each are incorporated herein by reference.

### FIELD

The present invention relates to a radio wave reflecting device for reflecting radio waves transmitted from a wave source and a radio wave reflecting system including the same.

### BACKGROUND

In the field of communications, the introduction of the fifth generation communications standard known as 5G is progressing. 5G uses radio waves in the millimeter wave band with frequencies between 26 GHz to 29 GHz. 5G communication enables transmission over a wide bandwidth and achieves very high throughput.

Since the radio waves in the millimeter wave band frequency travel with a high degree of straightness, it is difficult for radio waves emitted from base stations to reach areas such as the rear side of a building. For this reason, in areas where it is difficult for radio waves to reach, a radio wave reflecting surface such as that disclosed in Japanese Unexamined Patent Application Publication (Translation of PCT Application) No. 2019-530387 is installed to change the transmission direction of radio waves.

In the radio wave reflecting surface, to uniformly reflect radio waves, the incidence of non-directional radio waves is required. Therefore, the radio wave reflecting surface must be placed at a sufficient distance from a wave source. The distance from the wave source increases as the frequency of the radio waves becomes higher and the area of the radio wave reflecting surface becomes larger.

### SUMMARY

An intelligent reflecting surface according to an embodiment of the present invention comprises a plurality of reflecting devices, the plurality of reflecting devices is arranged adjacent to each other, the plurality of reflecting devices includes a first reflecting device and a second reflecting device adjacent to the first reflecting device, a reflecting surface of the first reflecting device forms an angle θ with a reflecting surface of the second reflecting device, and the angle θ is greater than 0° and less than 90°.

### BRIEF DESCRIPTION OF DRAWINGS

FIG. 1 is a schematic front view of a radio wave reflecting device according to an embodiment of the present invention.

FIG. 2 is a cross-sectional schematic view along a line II-II of the radio wave reflecting device shown in FIG. 1.

FIG. 3 is a plan view of a radio wave reflecting surface (liquid crystal reflecting surface) according to an embodiment of the present invention.

FIG. 4 is a cross-sectional view between A-B of the liquid crystal reflecting surface shown in FIG. 3.

FIG. 5 is a plan view of a unit cell forming a liquid crystal reflecting surface.

FIG. 6 is a cross-sectional view between C-D of the unit cell shown in FIG. 5.

FIG. 7 is a schematic diagram showing how the travelling direction of scattered waves is changed by a liquid crystal reflecting surface.

FIG. 8 is a schematic diagram of a radio wave reflecting system according to an embodiment of the present invention.

FIG. 9 is a schematic diagram of a radio wave reflecting system according to an embodiment of the present invention.

### DESCRIPTION OF EMBODIMENTS

Hereinafter, embodiments of the present invention will be described with reference to the drawings. The width, thickness, shape, and the like of each part may be schematically represented in comparison with the actual embodiments in order to clarify the description, but the drawings are merely examples and do not limit the interpretation of the present invention. In the present specification and the drawings, elements similar to those described above with respect to the previous figures are denoted by the same reference signs and detailed description thereof may be omitted as appropriate.

### [Radio Wave Reflecting Device]

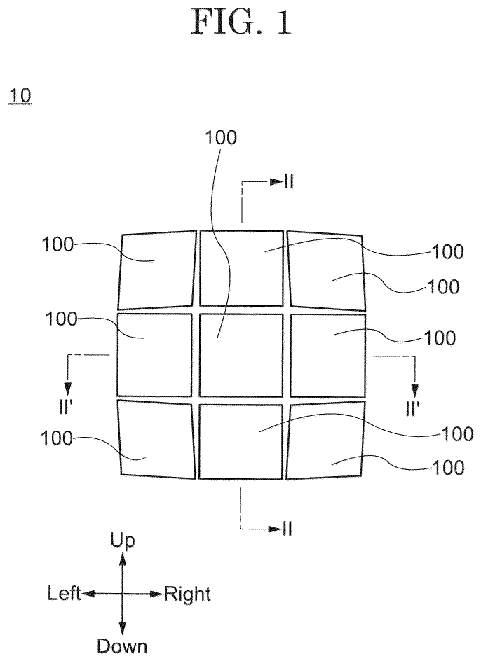

FIG. 1 is a schematic front view of a radio wave reflecting device 10 according to an embodiment of the present invention. As shown in FIG. 1, the radio wave reflecting device 10 includes a plurality of radio wave reflecting surfaces 100 arranged adjacent to each other. The radio wave reflecting device 10 may include a control device that can adjust the reflection angle of radio waves incident on each of the plurality of radio wave reflecting surfaces 100. The radio wave reflecting device 10 is configured to reflect incident radio waves. In addition, the radio wave reflecting device 10 can be referred to as an Intelligent Reflecting Surface (IRS). The radio wave reflecting surface 100 can be referred to as a reflecting device.

The radio wave reflecting device 10 has a total of 9 radio wave reflecting surfaces 100 arranged symmetrically in the up and down direction and the left and right direction, with 3 plates in the up and down direction and 3 plates in the left and right direction. The direction and number of the arranged radio wave reflecting surfaces 100 are not limited to this, and may be, for example, 2 plates in the up and down direction and 1 plate in the left and right direction for a total of 2 plates, 2 plates in the up and down direction and 2 plates in the left and right direction for a total of 4 plates, and 5 plates in the up and down direction and 5 plates in the left and right direction for a total of 25 plates. In addition, the up and down direction and the left and right direction are used for explanation and specifically refer to the directions shown in FIG. 1.

The radio wave reflecting device 10 has a square plate-shaped radio wave reflecting surface 100 when viewed from the front. The shape of the radio wave reflecting surface 100 is not limited to this, and examples thereof include a rectangular plate shape when viewed from the front, and a circular plate shape when viewed from the front. In the case of the square plate-shaped radio wave reflecting surface 100 when viewed from the front, the size is set to, for example, 50 mm or more and 1000 mm or less on a side, and 1 mm or more and 10 mm or less in thickness.

The radio wave reflecting device 10 has liquid crystal reflecting surfaces containing a liquid crystal arranged as the radio wave reflecting surface 100. The radio wave reflecting surface 100 is not limited to this, and examples thereof include a metal plate, a meta-surface reflecting plate, and a liquid crystal reflecting surface. Among these, from the viewpoint of arbitrarily controlling the reflection angle of radio waves, the liquid crystal reflecting surface is preferred. A specific configuration of the liquid crystal reflecting surface will be described later.

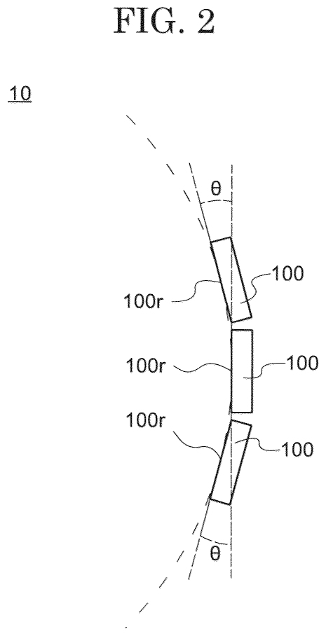

FIG. 2 is a cross-sectional schematic view along a line II-II in FIG. 1. Since the radio wave reflecting surface 100 in the radio wave reflecting device 10 is arranged symmetrically in the up and down direction and left and right direction, the cross-sectional schematic view along II′-II′ in FIG. 1 is also the same. As shown in FIG. 2, in a cross-sectional view, a reflecting surface 100r of a certain radio wave reflecting surface (for example, a first radio wave reflecting surface) 100 forms an angle θ with the reflecting surface 100r of an adjacent radio wave reflecting surface (for example, a second radio wave reflecting surface) 100. The angle θ is set to be greater than 0° and less than 90°.

In the radio wave reflecting device 10, the angle θ is fixed. The radio wave reflecting device 10 may further include an angle adjustment means between adjacent radio wave reflecting surfaces 100 to allow fine adjustment of the angle θ.

In the radio wave reflecting device 10, the radio wave reflecting surface 100 is arranged so that the center of the reflecting surface 100r is along a spherical surface whose radius is the distance from the surface of an antenna 20 that emits radio waves to the reflecting surface 100r. In other words, the plurality of radio wave reflecting surfaces 100 is arranged so that a curved surface inscribed in the reflecting surface 100r of a certain radio wave reflecting surface 100 and the reflecting surface 100r of the adjacent radio wave reflecting surface 100 is along a spherical surface. The arrangement of the radio wave reflecting surface 100 is not limited to this, and examples thereof include arrangements where the curved surface inscribed in the reflecting surface 100r is along a concave surface towards the antenna 20 or along a parabolic shape. Among these, from the viewpoint of converging the reflection direction of radio waves to one point, the arrangement along a parabolic shape is preferred.

### [Liquid Crystal Reflecting Surface]

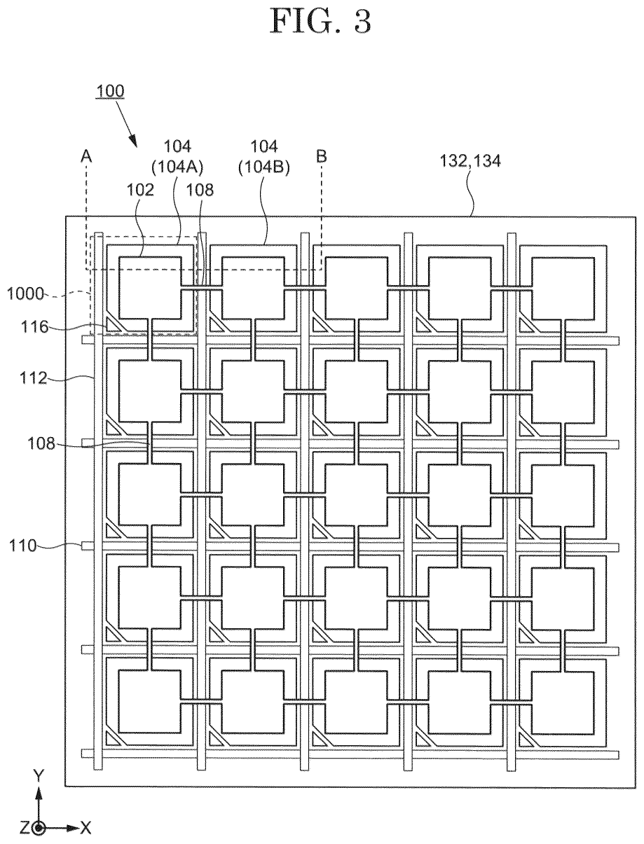

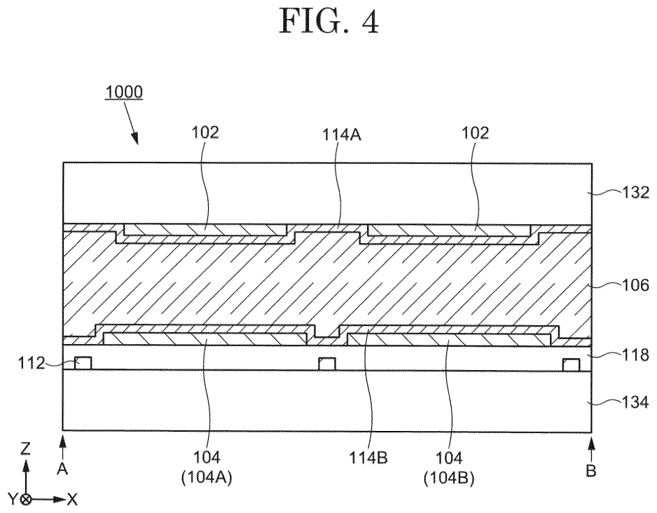

FIG. 3 is a plan view of a liquid crystal reflecting surface, which is the radio wave reflecting surface 100. FIG. 4 is a cross-sectional view corresponding to A-B shown in FIG. 3. In the following description, both FIG. 3 and FIG. 4 will be referred to as appropriate.

The liquid crystal reflecting surface 100 includes at least one common electrode 102, at least one bias electrode 104, and a liquid crystal layer 106 disposed between these electrodes. As shown in FIG. 3, the common electrodes 102 are arranged in the X-axis and Y-axis directions, and the bias electrodes 104 are arranged in a matrix in the X-axis and Y-axis directions corresponding to the common electrode 102. Therefore, the liquid crystal reflecting surface 100 has a structure in which a plurality of common electrodes 102 and a plurality of bias electrodes 104 are arranged to form a matrix respectively. In addition, the X-axis and Y-axis directions are used for explanation and specifically refer to the directions shown in FIG. 3. The X-axis and Y-axis directions can also be interpreted as one direction and another direction intersecting it.

Adjacent common electrodes 102 are interconnected by a common wiring 108. Adjacent common electrodes 102 are not necessarily connected by the common wiring 108 and may be connected only along the X-axis direction or only along the Y-axis direction. In contrast, the adjacent bias electrodes 104 are arranged with gaps and are physically separated. The common electrode 102 is provided on a first substrate 132, and the bias electrode 104 is provided on a second substrate 134. The liquid crystal reflecting surface 100 is a device that scatters radio waves incident on the incident surface in a predetermined direction, with the first substrate 132 disposed on the incident surface side and the second substrate 134 disposed on the rear side of the incident surface. That is, the common electrode 102 is arranged on the incident surface, and the bias electrode 104 is arranged on the rear surface of the common electrode 102 with the liquid crystal layer 106 in between.

The liquid crystal reflecting surface 100 has a structure in which the common electrode 102, the liquid crystal layer 106, and the bias electrode 104 are disposed to overlap in a plan view. In addition, the liquid crystal reflecting surface 100 is arranged so that the surface of the first substrate 132 with the common electrode 102 and the surface of the second substrate 134 with the bias electrode 104 face each other, with the liquid crystal layer 106 in between. The liquid crystal reflecting surface 100 has a basic unit formed of a stacked structure (which may also include the first substrate 132 and the second substrate 134) of a set of common electrodes 102, the liquid crystal layer 106, and the bias electrode 104. Hereinafter, this basic unit is referred to as a unit cell 1000.

The second substrate 134 is provided with a selection signal line 110 extending in the direction X, a bias signal line 112 extending in the direction Y, and a switching element 116. The switching element 116 is provided to correspond one-to-one with the bias electrode 104. The switching operation (on/off state) of the switching element 116 is controlled by a selection signal of the selection signal line 110, and a bias signal (bias voltage) is input from the bias signal line 112. The bias signal is individually input to the bias electrode 104 by the switching element 116. That is, the bias signal is individually input to the bias electrodes 104 arranged in a matrix by the switching element 116.

A first alignment film 114A is provided on the first substrate 132, and a second alignment film 114B is provided on the second substrate 134. The first alignment film 114A is provided to cover the common electrode 102, and the second alignment film 114B is provided to cover the bias electrode 104. The first alignment film 114A and the second alignment film 114B are provided to control an alignment state of the liquid crystal layer 106. The liquid crystal layer 106 contains elongated rod-shaped liquid crystal molecules. An initial alignment state (an alignment state without the influence of an electric field) of the liquid crystal molecules is controlled by the first alignment film 114A and the second alignment film 114B.

The first alignment film 114A and the second alignment film 114B can have any composition as long as they have the function of aligning liquid crystal molecules, and may be made of either an organic material or an inorganic material, polyimide, or the like. In addition, although an alignment direction may be a horizontal alignment, vertical alignment, or a tilt alignment, the present embodiment shows the case of a horizontal alignment film.

The alignment state of the liquid crystal molecules in the liquid crystal layer 106 is controlled by the bias electrode 104. Since the bias voltage applied to the bias electrode 104 can be controlled for each unit cell 1000, the alignment state of the liquid crystal molecules in the liquid crystal layer 106 can also be controlled for each unit cell 1000. The dielectric constant of the liquid crystal layer 106 changes depending on the alignment state of the liquid crystal molecules. The phase of scattered waves of the liquid crystal reflecting surface 100 changes depending on the dielectric constant of the liquid crystal layer 106. Therefore, by changing the dielectric constant of the liquid crystal layer 106 for each unit cell 1000, a phase difference can be generated within the plane of the liquid crystal reflecting surface 100, and the travelling direction of the scattered wave can be controlled.

Since the liquid crystal reflecting surface 100 scatters incident waves incident on the surface on which the common electrode 102 is arranged, the common electrode 102 is also referred to as a scatterer. In addition, the unit cell 1000 can also be regarded as a patch antenna in which a patch electrode (the common electrode 102) is provided on the upper surface of a dielectric (the liquid crystal layer 106) and a reflecting electrode (the bias electrode 104) is provided on the rear surface.

Although not shown in FIG. 3 and FIG. 4, the second substrate 134 may be provided with a drive circuit for outputting the selection signal to the selection signal line 110 and a drive circuit for outputting the bias signal to the bias signal line 112. In addition, signals for driving the drive circuits and an input terminal for inputting a driving power may be provided.

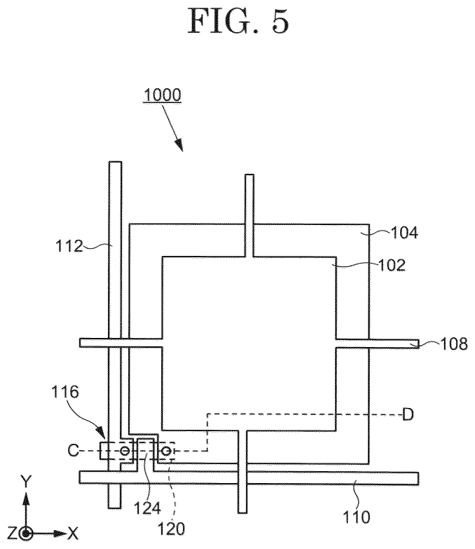

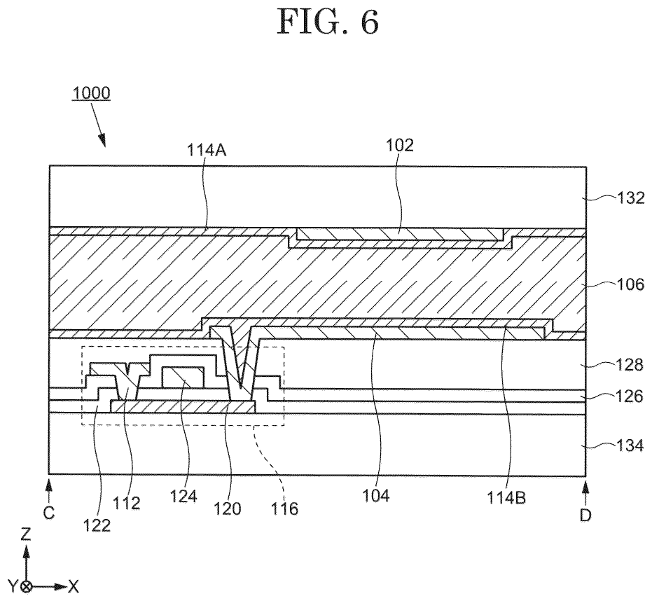

FIG. 5 and FIG. 6 show details of the unit cell 1000 forming the liquid crystal reflecting surface 100. FIG. 5 shows a plan view of the unit cell 1000, and FIG. 6 is a cross-sectional view between C-D shown in FIG. 5. As shown in FIG. 5 and FIG. 6, the unit cell 1000 is arranged so that the common electrode 102, the liquid crystal layer 106, and the bias electrode 104 overlap in a plan view.

The common electrode 102 used in the present embodiment has a symmetrical shape with respect to the vertical polarization and the horizontal polarization of the incident radio waves. FIG. 5 shows an example in which the common electrode 102 is square. The size (vertical and horizontal dimensions) of the common electrode 102 is appropriately set according to the frequency of the target radio wave. In addition, the shape of the common electrode 102 is not limited to a square, and may be a rectangle or may have other geometric shapes.

The common electrode 102 is connected to the common wiring 108. The common wiring 108 has a predetermined length and width. One end of the common wiring 108 is connected to a center point of one side of the common electrode 102. In other words, the common wiring 108 is connected so that the center point of one side of the common electrode 102 is included in the width portion of the common wiring 108. Although the connection structure of the common wiring 108 and the common electrode 102 is not limited, for example, the common wiring 108 and the common electrode 102 are formed in the same conductive layer. The common wiring 108 is connected to a power circuit (not shown). Alternatively, the common wiring 108 is grounded or connected to a grounded wiring. As shown in FIG. 3, the common wiring 108 connects adjacent common electrodes 102. The common electrodes 102 are connected by the common wiring 108, so that the common electrodes 102 arranged in a matrix have an equipotential.

The bias electrode 104 is formed in a large area to have a function as a reflecting surface. As shown in FIG. 5, in the unit cell 1000, the bias electrode 104 has a larger area than the common electrode 102. The bias electrode 104 and the common electrode 102 are provided to overlap, and in this case, the common electrode 102 is disposed in a region inside the bias electrode 104.

The bias electrode 104 is connected to the bias signal line 112 via the switching element 116. FIG. 5 and FIG. 6 show an example in which the switching element 116 is formed of a transistor. The transistor has a structure in which a semiconductor layer 120, a gate insulating layer 122, and a gate electrode 124 are stacked. An interlayer insulating layer 126 is provided on the gate electrode 124 and the bias signal line 112 is provided thereon. The switching element 116 and the bias signal line 112 are filled with a planarization layer 128. The bias electrode 104 is provided on the planarization layer 128. The bias electrode 104 is connected to an input/output terminal (drain) of the switching element (transistor) 116 via a contact hole. In addition, the gate electrode 124 of the switching element (transistor) 116 is connected to the selection signal line 110, and an input/output terminal (source) not connected to the bias electrode 104 is connected to the bias signal line 112.

The alignment state of the liquid crystal molecules in the liquid crystal layer 106 is controlled by the bias electrode 104. That is, the alignment state of the liquid crystal molecules in the liquid crystal layer 106 is controlled by the bias signal applied to the bias electrode 104. The bias signal is a DC voltage signal or a polarity-inverted DC voltage signal in which a positive DC voltage and a negative DC voltage are alternately inverted.

The liquid crystal layer 106 is formed of a liquid crystal material having dielectric anisotropy. For example, the liquid crystal material forming the liquid crystal layer 106 may be any material that exhibits liquid crystallinity and has dielectric anisotropy, and a nematic liquid crystal is particularly preferred. The effect of the present embodiment is unchanged regardless of whether the dielectric anisotropy of the liquid crystal material is positive or negative. Hereafter, the present embodiment will be described with reference to the liquid crystal layer 106 having positive dielectric anisotropy.

The dielectric constant of the liquid crystal layer 106 changes depending on the alignment state of the liquid crystal molecules. The alignment state of the liquid crystal molecules is controlled by the bias electrode 104. When the incident wave is scattered by the unit cell 1000, the phase of the scattered wave changes depending on the dielectric constant of the liquid crystal layer.

The frequency bands reflected by the liquid crystal reflecting surface 100 are a very high frequency (VHF) band, an ultra high frequency (UHF) band, a super high frequency (SHF) band, a tremendously high frequency (THF) band, an extra high frequency (EHF) band, and a terahertz wave band. The alignment of the liquid crystal molecules in the liquid crystal layer 106 changes depending on the bias voltage applied to the bias electrode 104, but does not substantially follow the frequency of the radio wave incident on the common electrode 102. Due to such characteristics of the liquid crystal molecules, the dielectric constant of the liquid crystal layer 106 can be changed by the bias electrode 104, radio waves can be scattered by the common electrode 102, and the phase of the scattered radio wave can be controlled.

The first substrate 132 and the second substrate 134 are provided to sandwich the liquid crystal layer 106 and form a wiring or the like, and are formed of a flat material such as glass, resin, or a metal plate. In this case, transparency is not an issue. In addition, each layer provided in the first substrate 132 and the second substrate 134 is formed using the following materials. The semiconductor layer 120 is provided to form the switching element 116 and is formed of an oxide semiconductor including amorphous silicon, silicon semiconductors such as polycrystalline silicon, and metal oxides such as indium oxide, zinc oxide, gallium oxide, and the like. The gate insulating layer 122 and the interlayer insulating layer 126 are provided to insulate each wiring layer, and therefore may be made of any insulating material, such as a silicon oxide film, a silicon nitride film, or a stacked structure thereof. The selection signal line 110 and the gate electrode 124 are provided to transmit an electrical signal, and are preferably made of a conductive material, such as a metal film. For example, the selection signal line 110 and the gate electrode 124 are made of molybdenum (Mo), tungsten (W), or an alloy thereof. The bias signal line 112 is provided to transmit an electrical signal, and is preferably made of a conductive material, such as a metal film. For example, the bias signal line 112 is made of a stacked structure of titanium (Ti)/aluminum (Al)/titanium (Ti), or a stacked structure of molybdenum (Mo)/aluminum (Al)/molybdenum (Mo). The planarization layer 128 is formed to planarize irregularities and the like formed by switching elements and the like. Any material having flatness and insulating properties may be used, for example, an organic material is desirable, and an acrylic resin, an epoxy resin, a polyimide material, or the like can be used. The common electrode 102, the bias electrode 104, and the common wiring 108 have a function of conducting a signal for driving a liquid crystal and a function of scattering input radio waves. Both may be conductive, and a metal film or the like may be used. Particularly, a material with low conductivity is desirable, and for example, aluminum, copper, gold, or an alloy using the same can be used. Further, in order to reduce resistance, it is desirable to make the thickness of the common electrode 102, the bias electrode 104, and the common wiring 108 thicker than that of the bias signal line and the selection signal line.

In addition, although not shown in FIG. 6, the first substrate 132 and the second substrate 134 are disposed to have a gap therebetween, and are bonded together with a sealing material. The sealing material only needs to have a function of bonding the first substrate 132 and the second substrate 134 together, and is formed of an organic material such as an acrylic resin or an epoxy resin. The liquid crystal layer 106 is sealed in a region surrounded by the first substrate 132, the second substrate 134, and the sealing material. The gap between the first substrate 132 and the second substrate 134 is approximately 20 μm to 100 μm, for example, 40 μm. Although not shown, a spacer may be provided between the first substrate 132 and the second substrate 134 to keep the gap constant.

As shown in FIG. 5, the common electrodes 102 arranged in a matrix are mutually connected by the common wiring 108, and the bias electrode 104 is connected to the bias signal line 112 via the switching element 116 so that the potential can be individually controlled, whereby the dielectric constant of the liquid crystal layer 106 can be changed for each unit cell 1000. As a result, the phase of the scattered wave can be controlled for each unit cell 1000.

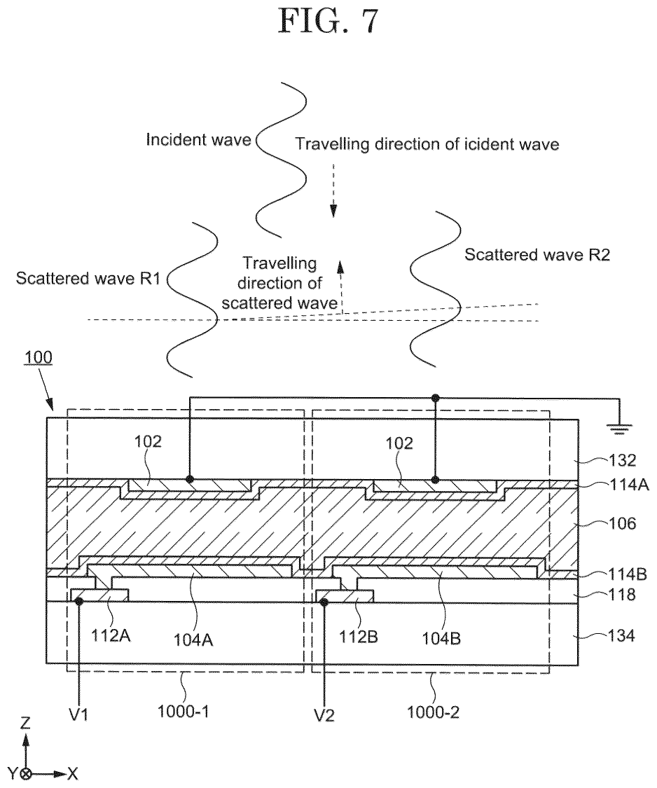

FIG. 7 schematically shows an embodiment in which the travelling direction of the scattered wave is changed by a first unit cell 1000-1 and a second unit cell 1000-2. A bias signal V1 is applied from a bias signal line 112A to a bias electrode 104A of the first unit cell 1000-1, and a bias signal V2 is applied from a bias signal line 112B to a bias electrode 104B of the second unit cell 1000-2. In this case, the bias signal V1 and the bias signal V2 have different voltage levels (V1≠V2). The common electrodes 102 of the first unit cell 1000-1 and the second unit cell 1000-2 have the same potential, and are set to, for example, a common potential.

FIG. 7 schematically shows that, when the radio wave is incident on the first unit cell 1000-1 and the second unit cell 1000-2 in the same phase, since different bias signals (V1≠V2) are applied to the first unit cell 1000-1 and the second unit cell 1000-2, the phase change of the scattered wave due to the second unit cell 1000-2 is larger than that of the first unit cell 1000-1. As a result, the phase of the scattered wave R1 scattered by the first unit cell 1000-1 is different from the phase of the scattered wave R2 scattered by the second unit cell 1000-2 (in FIG. 7, the phase of the scattered wave R2 is advanced from the phase of the scattered wave R1), and apparently, the travelling direction of the scattered wave changes in an oblique direction.

As shown in FIG. 7, the liquid crystal reflecting surface 100 can cause the phase of the scattered wave of the incident wave to differ between the first unit cell 1000-1 and the second unit cell 1000-2. FIG. 7 schematically shows two unit cells, but in practice, by individually controlling the unit cells 1000 arranged in a matrix, the travelling direction of the scattered wave can be controlled in any direction without changing the direction of the liquid crystal reflecting surface 100. Since the plurality of common electrodes 102 arranged on the reflecting surface of the liquid crystal reflecting surface 100 is held at a constant potential (for example, a ground potential), the bias electrodes 104A and 104B and the bias signal lines 112A and 112B for applying the bias voltage to the liquid crystal layer 106 are arranged on the rear surface of the common electrode 102, it is possible to prevent the front surface of the liquid crystal reflecting surface 100 from being affected by the electric field generated by the bias signal lines 112A and 112B.

### [Radio Wave Reflecting System]

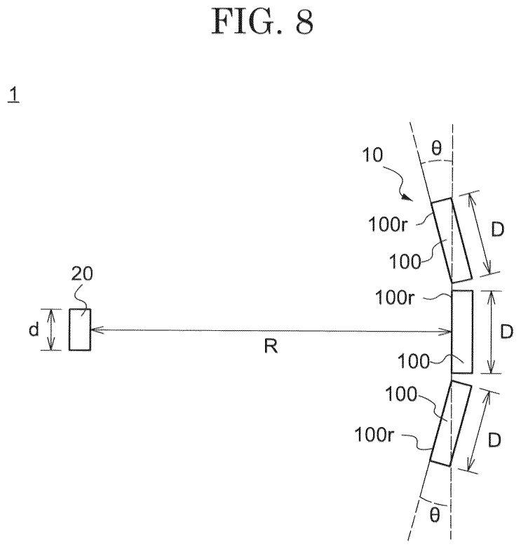

FIG. 8 is a schematic diagram of a radio wave reflecting system 1 according to an embodiment of the present invention. As shown in FIG. 8, the radio wave reflecting system 1 includes the antenna 20 and the radio wave reflecting device 10. The antenna 20 is configured to emit radio waves. For example, the antenna 20 is installed at a base station and serves as a wave source of the transmitted radio waves. In addition, the radio wave reflecting system 1 can be referred to as a reflecting system.

In the radio wave reflecting system 1, when the diameter of the antenna 20 is d, the wavelength of the radio wave is A, the diameter of the radio wave reflecting surface 100 is D, and the distance from the antenna 20 to the radio wave reflecting surface 100 is R, and the radio wave reflecting surface 100 is disposed to satisfy the following Expression (1). In Expression (1), for example, units of millimeters can be used for the diameter d, the wavelength λ, the diameter D, and the distance R.

R≥2(D+d)²/λ (1)

By satisfying Expression (1), the radio wave reflecting surface 100 is in the far field from the antenna 20, and non-directional radio waves are incident. As shown in Expression (1), the shorter the wavelength λ (the higher the frequency), and the longer the diameter D of the radio wave reflecting surface 100 (the larger the area), the longer the required distance R from the antenna 20 to the radio wave reflecting surface 100 becomes.

In the radio wave reflecting system 1, an angle θ is formed between the reflecting surface 100r of the radio wave reflecting surface 100 and the reflecting surface 100r of the adjacent radio wave reflecting surface 100. If the angle θ is not formed (if the angle θ is 0°), the diameter of the radio wave reflecting surface 100 must be 3D and satisfy Expression (1). However, by forming the angle θ, it is sufficient for the diameter of the radio wave reflecting surface 100 to be D, which is ⅓ of 3D, and satisfy Expression (1). Therefore, the distance R from the antenna 20 to the radio wave reflecting surface 100 can be reduced.

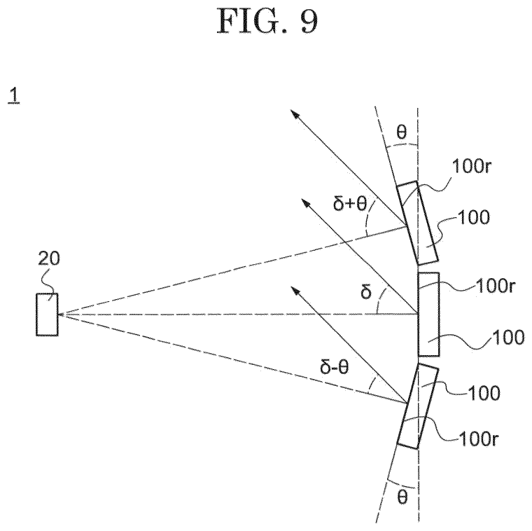

Further, in the radio wave reflecting system 1, the angle θ is formed between the reflecting surface 100r of the radio wave reflecting surface 100 and the adjacent radio wave reflecting surface 100. As shown in FIG. 9, the radio wave reflecting device 10 is configured to align the overall reflection direction of radio waves by reflecting the radio waves so that when the reflection angle of the radio wave on the reflecting surface 100r of a certain radio wave reflecting surface 100 is δ, the reflection angle of the radio wave on the reflecting surface 100r of the adjacent radio wave reflecting surface 100 becomes δ±θ. When the radio wave reflecting surface 100 is the liquid crystal reflecting surface, the bias signal applied to the unit cell 1000 of the liquid crystal reflecting surface is adjusted so that the reflection angle of the radio wave on the reflecting surface 100r of a certain liquid crystal reflecting surface becomes δ. Then, in the adjacent liquid crystal reflecting surface, the bias signal applied to the unit cell 1000 of the liquid crystal reflecting surface is adjusted so that the reflection angle of the radio wave on the reflecting surface 100r becomes δ±θ. In this way, by using a liquid crystal reflecting surface as the radio wave reflecting surface 100, the radio wave reflecting device 10 can easily control the reflection direction of each radio wave reflecting surface 100 forming the radio wave reflecting system 1, and can align the overall reflection direction of the radio waves.

Further, it is understood that, even if the effect is different from those provided by each of the above embodiments, the effect obvious from the description in the specification or easily predicted by persons ordinarily skilled in the art is apparently derived from the present invention.

What is claimed is:

1. An intelligent reflecting surface comprising:
a plurality of reflecting devices,
wherein the plurality of reflecting devices is arranged adjacent to each other,
the plurality of reflecting devices includes a first reflecting device and a second reflecting device adjacent to the first reflecting device,
a reflecting surface of the first reflecting device forms an angle θ with a reflecting surface of the second reflecting device, and
the angle θ is greater than 0° and less than 90°.

2. The intelligent reflecting surface according to claim 1, wherein
the plurality of reflecting devices is arranged so that a curved surface inscribed in the reflecting surface of the first reflecting device and the reflecting surface of the second reflecting device is along a parabolic shape.

3. The intelligent reflecting surface according to claim 1, wherein
the intelligent reflecting surface is configured to reflect a radio wave so that when a reflection angle of the radio wave on a reflecting surface of the first reflecting device is δ, a reflection angle of the radio wave on a reflecting surface of the second reflecting device becomes the reflection angle δ±the angle θ.

4. The intelligent reflecting surface according to claim 1, wherein
each of the plurality of reflecting devices includes a liquid crystal.

5. A reflecting system comprising an antenna and the intelligent reflecting surface according to claim 1, wherein
the antenna is configured to emit radio waves,
the intelligent reflecting surface is configured to reflect the incident radio waves,
in the plurality of reflecting devices, the relationship between a diameter d of the antenna, a wavelength λ of the radio wave, a diameter D of the reflecting device, and a distance R from the antenna to the reflecting device satisfies the following Expression (1)
R≥2(D+d)²/λ (1).
